(19) United States
(12) Patent Application Publication
(10) Pub. No.: US 2017/0270611 A1
(43) Pub. Date: Sep. 21, 2017

(54) PROCESSING SYSTEM TO AUTOMATICALLY ASSIGN ELECTRONIC RECORDS TO VERIFICATION PROCESS SUBSET LEVELS

(71) Applicants: Shayne J. Boundy, Avon, CT (US); Stanislav Ivanov Gotchev, Bloomfield, CT (US); Eric G. Kitchens, Hartford, CT (US)

(72) Inventors: Shayne J. Boundy, Avon, CT (US); Stanislav Ivanov Gotchev, Bloomfield, CT (US); Eric G. Kitchens, Hartford, CT (US)

(21) Appl. No.: 15/074,007

(22) Filed: Mar. 18, 2016

(51) Int. Cl. G06Q 40/08

(52) U.S. Cl. CPC G06Q 40/08

(57) ABSTRACT

Mediums, apparatus, computer program code, and means may be provided to assign electronic records to verification process subset levels via an automated back-end application computer server. According to some embodiments, the server may access a data store having electronic records that represent a plurality of risk associations and, for each risk association, a set of attribute variables. Based on the set of attribute variables and a predictive model, the server may predict a future amount for each of the electronic records. Based on the future amounts, the server may automatically assign each of the electronic records to: a first level verification process subset, a second level verification process subset, or a third level verification process subset. The server may then create a results log and transmit indications associated with the results log to generate an interactive user interface display.

### BACKGROUND

Electronic records, such as files and database entries, may be stored and utilized by an enterprise. In some cases, the enterprise may want to verify the content of one or more electronic records. For example, more accurate electronic records may improve the performance of the enterprise. Moreover, different verification techniques or processes may be utilized and different verification processes may be associated with different costs, delays, improvements in data accuracy, etc. Note that improving the accuracy of electronic records may result in substantial improvements to the operation of a network (e.g., by reducing an overall number of electronic messages that need to be created and transmitted via the network). Manually determining which verification process should be utilized in connection with each electronic record, however, can be a time consuming and error prone task—especially when a substantial number of electronic records (e.g., tens of thousands of records) and/or a wide range of factors may result in one particular verification technique being more appropriate for a specific record as compared to other verification techniques.

It would be desirable to provide systems and methods to automatically improve the assignment of electronic records to verification process subset levels in a way that provides faster, more accurate results and that allows for flexibility and effectiveness when responding to those results.

### SUMMARY OF THE INVENTION

According to some embodiments, systems, methods, apparatus, computer program code and means are provided to automatically improve the assignment of electronic records to verification process subset levels. In some embodiments, a server may access a data store having electronic records that represent a plurality of risk associations and, for each risk association, a set of attribute variables. Based on the set of attribute variables, the server may predict a future amount for each of the electronic records. Based on the future amounts, the server may automatically assign each of the electronic records to: a first level verification process subset, a second level verification process subset, or a third level verification process subset. The server may then create a results log and transmit indications associated with the results log to generate an interactive user interface display.

Some embodiments comprise: means for accessing, by a back-end application computer server, a data store having electronic records that represent a plurality of risk associations and, for each risk association, a set of attribute variables; based on the set of attribute variables, means for automatically predicting, by the back-end application computer server, a future amount for each of the electronic records; based on the future amounts, means for automatically assigning, by the back-end application computer server, each of the electronic records to one of the following verification process subset levels: a first level verification process subset, a second level verification process subset, the second level verification process subset being more thorough as compared to the first level verification process subset, and a third level verification process subset, the third level verification process subset being more thorough as compared to the first and second level verification process subsets; means for creating, by the back-end application computer server, a results log based on the automatic assignments of the electronic records; and means for transmitting, by the back-end application computer server, indications associated with the results log via a communication port to generate an interactive user interface display.

In some embodiments, a communication device associated with a back-end application computer server exchanges information with remote devices. The information may be exchanged, for example, via public and/or proprietary communication networks.

A technical effect of some embodiments of the invention are improved and computerized ways to automatically improve the assignment of electronic records to verification process subset levels to provide faster, more accurate results and that allow for flexibility and effectiveness when responding to those results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system according to some embodiments.

FIG. 2 illustrates a method according to some embodiments of the present invention.

FIG. 3 is a verification process flow in accordance with some embodiments of the present invention.

FIG. 4 is a verification timeline according to some embodiments.

FIG. 5 is a high-level block diagram of an insurance enterprise system according to some embodiments of the present invention.

FIG. 6 illustrates an exemplary model score display that might be associated with various embodiments.

FIG. 7 illustrates an exemplary audit type allocation display according to some embodiments of the present invention.

FIG. 8 is a block diagram of an apparatus in accordance with some embodiments of the present invention.

FIG. 9 is a portion of a tabular database storing results in accordance with some embodiments.

FIG. 10 illustrates a system having a predictive model in accordance with some embodiments.

FIG. 11 illustrates a tablet computer displaying an audit level assignment platform results log according to some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of electronic record verification by providing benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third party systems, networks and subsystems. For example, in the present invention information may be transmitted to remote devices from a back-end application server and results may then be analyzed accurately to evaluate the accuracy of various electronic records, thus improving the overall performance of the system associated with message storage requirements and/or bandwidth considerations (e.g., by reducing the number of messages that need to be transmitted via a network). Moreover, embodiments associated with automatic verification process level assignments might further improve communication network performance, call center response times, real time chat availability, etc.

Electronic records may be stored and utilized by an enterprise. In some cases, the enterprise may want to verify the content of one or more electronic records. For example, more accurate electronic records may improve the performance of the enterprise. Moreover, different verification techniques or processes may be utilized and different verification processes may be associated with different costs, delays, improvements in data accuracy, etc. Note that improving the accuracy of electronic records may result in substantial improvements to the operation of a network (e.g., by reducing an overall number of electronic messages that need to be created and transmitted via the network). Manually determining which verification process should be utilized in connection with each electronic record, however, can be a time consuming and error prone task—especially when a substantial number of electronic records (e.g., tens of thousands of records) and/or a wide range of factors may result in one particular verification technique being more appropriate for a particular record as compared to other verification techniques.

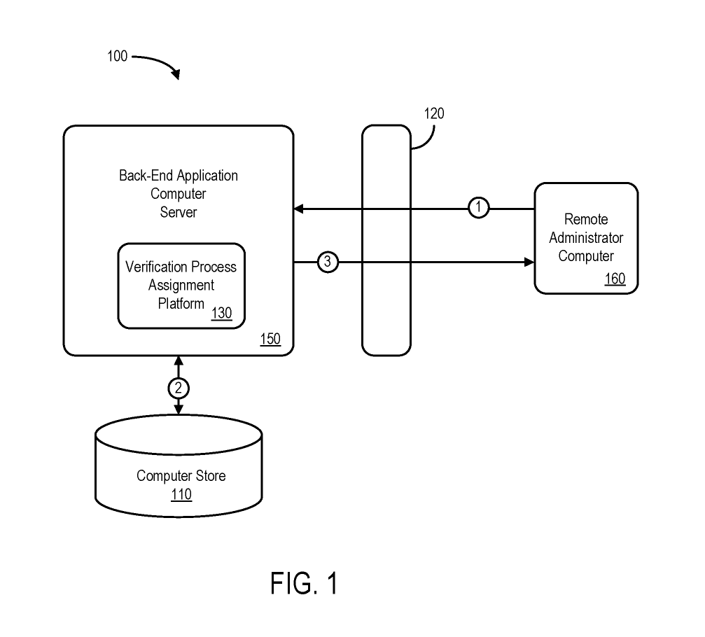

It would be desirable to provide systems and methods to automatically improve the assignment of electronic records to verification process subset levels in a way that provides faster, more accurate results and that allows for flexibility and effectiveness when responding to those results. FIG. 1 is a high-level block diagram of a system 100 according to some embodiments of the present invention. In particular, the system 100 includes a back-end application computer server 150 that may access information in a computer store 110 (e.g., storing a set of electronic records representing risk associations, each record including one or more communication addresses, attribute variables, etc.). The back-end application computer server 150 may also exchange information with a remote administrator computer 160 (e.g., via a firewall 120). According to some embodiments, a verification process assignment platform 130 of the back-end application computer server 150 may facilitate an assignment of an electronic record to a particular verification technique and/or the display of results via one or more remote administrator computers 160. Note that embodiments may be associated with periodic (or asynchronous) types of scheduling. Further note that the back-end application computer server 150 might be associated with a third party, such as a vendor that performs a service for an enterprise.

The back-end application computer server 150 might be, for example, associated with a Personal Computer (“PC”), laptop computer, smartphone, an enterprise server, a server farm, and/or a database or similar storage devices. According to some embodiments, an “automated” back-end application computer server 150 may facilitate the assignment of verification levels to electronic records in the computer store 110. As used herein, the term “automated” may refer to, for example, actions that can be performed with little (or no) intervention by a human.

As used herein, devices, including those associated with the back-end application computer server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the computer store 110. The computer store 110 might, for example, store electronic records representing risk associations, each electronic record being associated with a different communication address and/or attribute values. The computer store 110 may also contain information about past and current interactions with parties, including those associated with remote communication devices. The computer store 110 may be locally stored or reside remote from the back-end application computer server 150. As will be described further below, the computer store 110 may be used by the back-end application computer server 150 to assign electronic records to a particular verification level. Although a single back-end application computer server 150 is shown in FIG. 1, any number of such devices may be included. Moreover, various devices described herein might be combined according to embodiments of the present invention. For example, in some embodiments, the back-end application computer server 150 and computer store 110 might be co-located and/or may comprise a single apparatus.

According to some embodiments, the system 100 may automatically assign electronic records to a verification process via the automated back-end application computer server 150. For example, at (1 ) the remote administrator computer 160 may request that a batch of electronic records be automatically assigned to verification techniques. The verification process assignment platform 130 may then access information in the computer store at (2) and transmit a results log to the administrator at (3) (e.g., indicating which verification technique should be used for each electronic record).

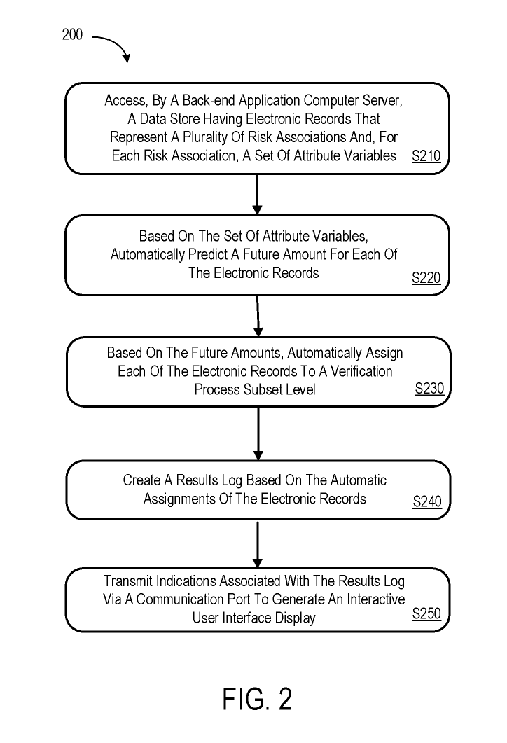

Note that the system 100 of FIG. 1 is provided only as an example, and embodiments may be associated with additional elements or components. According to some embodiments, the elements of the system 100 automatically generates and launches messages (and evaluates responses to those messages) over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, an automated back-end application computer server may access the electronic records in a data store that contains electronic records representing a plurality of risk associations and, for each risk association, a set of attribute variables. Based on the set of attribute variables and a predictive model, at S220 the system may automatically predict a “future amount” for each of the electronic records. For example, the predictive model might use attribute values to predict a future value that is expected to be associated with an electronic record (and related risk association).

Based on the future amounts, at S230 the system may automatically assign each of the electronic records to a verification process subset level. According to some embodiments, the verification process subset levels include: a first level verification process subset; a second level verification process subset, the second level verification process subset being more thorough as compared to the first level verification process subset (e.g., the second level might be more likely to catch and correct inaccurate entries in an electronic record); and a third level verification process subset, the third level verification process subset being more thorough as compared to the first and second level verification process subsets.

At S240, the system may create a results log based on the automatic assignments of the electronic records. At S250, the system may transmit indications associated with the results log to generate an interactive user interface display.

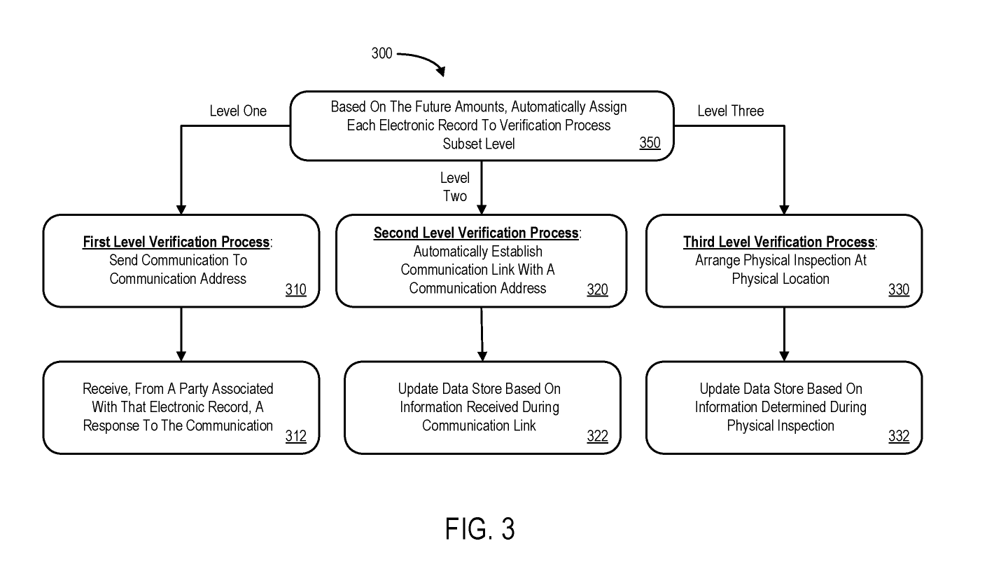

Consider, by way of example, FIG. 3 which is a verification process flow 300 in accordance with some embodiments of the present invention. Note that the process 300 might be performed as batches of insurance policies are undergoing a renewal process. For example, each month hundreds or thousands of insurance policies might be due for a yearly renewal process to help ensure that the premium accurately reflects the payroll size and risk exposure that is being insured. When a substantial number of audits are being scheduled, it might not be practical for an operator or administrator to schedule audit types for each individual policy in a logical and efficient manner. At 350, the system automatically assigns an electronic record one of the following verification process subset level (based on predicted future amounts): level one, level two, or level three. If the electronic record is assigned to level one, the electronic record may be associated with a communication address, and the first level verification process 310 comprises sending a communication to the communication address. For example the communication might be sent via a postal mailing automatically generated by a distribution center, an email automatically generated by an email server, and/or a web interface. At 312, the system may receive, from a party associated with that electronic record, a response to the communication. The response might be associated with, for example, a mailing received by the distribution center, an Interactive Voice Response (“IVR”) system associated with the call center, customer information provided via the web interface, and/or a chat application that interacts with customers in substantially real time.

If the electronic record is assigned to level two, the electronic record may be associated with a communication address, and the second level verification process 320 comprises establishing a communication link with the communication address. The communication link might be, for example, associated with a telephone call automatically placed from a call center, a video link, and/or a chat application that interacts with customers in substantially real time. The system may then update the data store at 322 based on information received during the communication link.

If the electronic record is assigned to level three, the electronic record may be associated with at least one physical location and the third level verification process 330 may comprise arranging a physical inspection at the least one physical location. The physical location might be associated with, for example, an office or factory address and the physical inspection might be performed by a risk engineer, manager, etc. The system may then update the data store at 332 based on information received during the physical inspection.

After the process 300 is complete, (e.g., for all of the insurance policies that are up for renewal that month), the results of the audits may be used to ensure that the associated insurance premium for each policy accurately reflects the current, actual payroll size and risk exposure that is being insured. The appropriate electronic records may then be updated and stored until the next yearly renewal process is due for that policy.

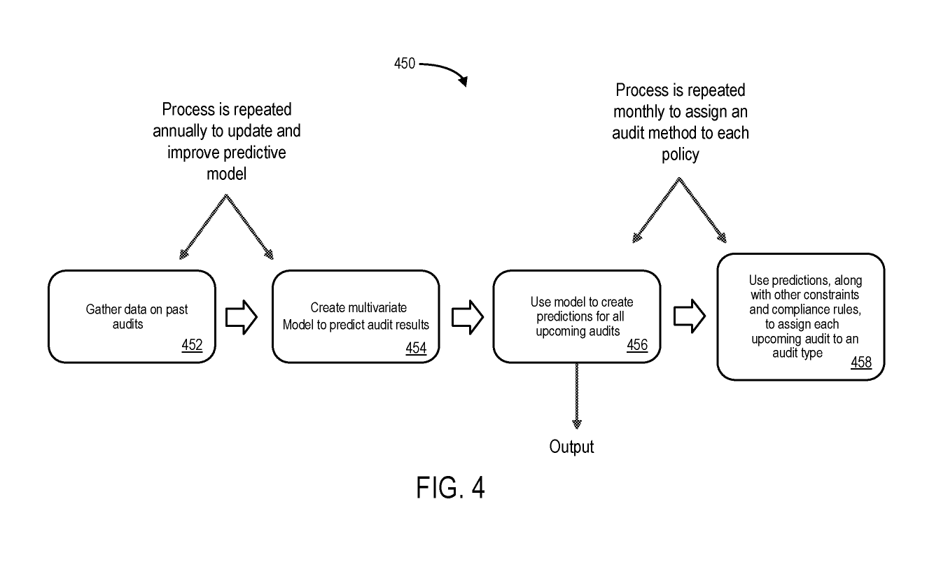

According to some embodiments, the risk associations are associated with insurance policies (e.g., general liability insurance, workers' compensation insurance, business insurance, etc.) and the automatically predicted future value comprises a future amount of a potential audit premium. For example, FIG. 4 is a verification timeline 450 for insurance policy audits according to some embodiments. In particular, at 452 data is gathered for past insurance policy audits and a multivariate model is created at 454 to predict audit results associated with insurance policy audit premiums. This might be performed, for example, on an annual basis to update and improve the predictive model. At 456, the model may be used to create predications for all upcoming audits and those predictions may be output. Those predictions may also be used at 458, along with other constraints and compliance rules, to assign each audit to an audit type (e.g., a first verification level associated with a mailed statement, a second verification level associated with a telephone call, or a third verification level associated with a physical inspection).

The selection of an appropriate verification level for an upcoming audit (e.g., associated with an electronic record that represents an insurance policy) might be based on one or more attribute variables stored in the electronic record. Note that each attribute variable may be associated with a rank (or weight) and the automatically predicted future amount of a potential audit premium may be based at least in part on the ranks (or weights) of the attribute variables. Also note that the automatic assignment of each of the insurance policies to the verification process subset levels might be further based at least in part on pre-defined targets for each of the subset levels. For example, an insurance enterprise may seek to perform a first percentage of statement audits (level one), a second percentage telephone audits (level two), and a third percentage on-site physical inspection audits (level three). Note that such target percentage values might be automatically calculated by the system (e.g., based on changing resource constraints, state regulations, etc.) and/or entered by an operator or administration. Also note that the target values might represent percentages, numbers of audits, dollar amounts, etc.

According to some embodiments, at least one attribute variable is associated with at least one of: policy characteristics, deposit premium, industry classification, employee work-type classification, geographic information (e.g., a state, a county, a ZIP code, etc.), measures of policy complexity (e.g., number of states, number of classifications, number of lines of business, etc.), indicators of policy changes (e.g., policy endorsement indicator, findings from prior audits, claim indicators, etc.), billing/payment characteristics (e.g., billing method, payment method, payment frequency, payment history, etc.), and third-party data (e.g., EXPERIAN® business credit data, Bureau of Labor Statistics economic data, EASY ANALYTIC SOFTWARE INC.® geodemographic data, etc.).

According to some embodiments, the automatically predicted future amount of a potential audit premium is based on a model utilizing a predicted amount of positive audit premiums. Such an approach might, for example, utilize tens of variables with relatively few strong predictors (and numerous other weaker predictors). According to other embodiments, the automatically predicted future amount of a potential audit premium is based on a model utilizing: a first model to predict a size of a predicted amount of positive audit premium, a second model to predict a size of a predicted amount of negative audit premium, and a third model to predict whether the predicted amount of audit premium would be positive or negative. Such an approach might be extremely complex (both because of an increase in a number of variables) with a marginal increase in prediction accuracy. In still other embodiments, the automatically predicted future amount of a potential audit premium is based on a model utilizing an absolute value of audit premiums. With this approach, larger absolute values might be associated with an increase in data inaccuracy and result in an appropriate allocation of audit resources allowing for audit resource expectations to be predicted many months into the future.

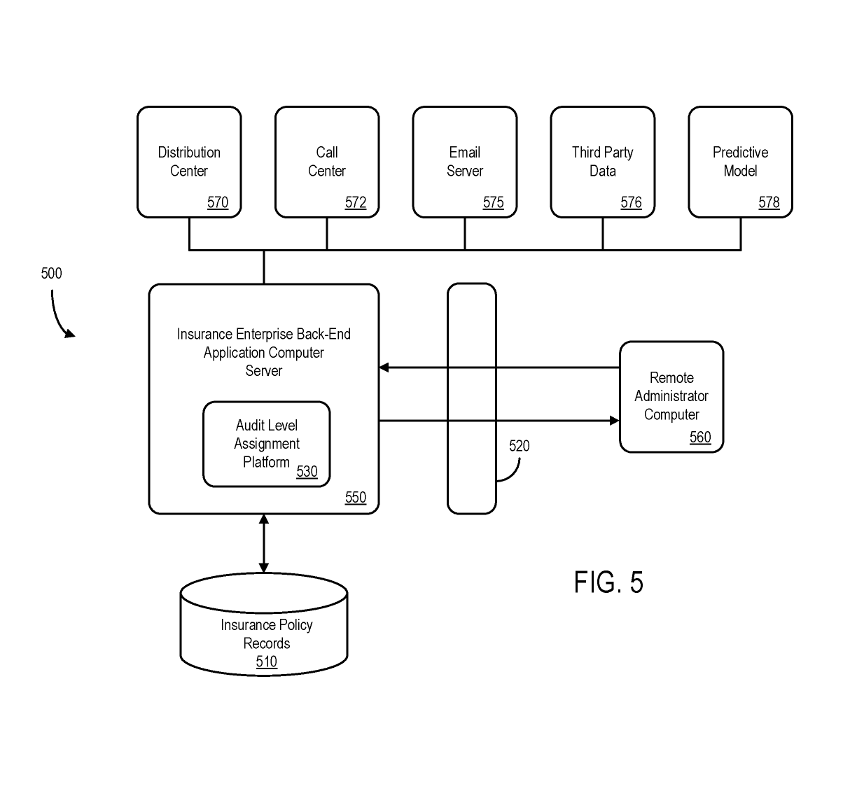

FIG. 5 is a high-level block diagram of an insurance enterprise system 500 according to some embodiments of the present invention. As before, the system 500 includes an insurance enterprise back-end application computer server 550 that may access information in insurance policy records 510 (e.g., storing a set of electronic records, each record representing an insurance policy and including one or more communication addresses, attribute variables, etc.). The back-end application computer server 550 may also exchange information with a remote administrator computer 560 (e.g., via a firewall 520). According to some embodiments, an audit level assignment platform 530 of the back-end application computer server 550 may facilitate an assignment of an electronic record to a particular verification technique (e.g., statement, telephone, or physical) and/or the display of results via one or more remote administrator computers 560. The verification technique might seek to ensure that information about the insurance policy (e.g., the total number of employees employed by a business, the address of a company office, etc.) is complete and accurate. The back-end application computer server 550 might be, for example, associated with a PC, laptop computer, smartphone, an enterprise server, a server farm, and/or a database or similar storage devices. Devices, including those associated with the back-end application computer server 550 and any other device described herein may exchange information via any communication network which may be one or more of a LAN, a MAN, a WAN, a proprietary network, a PSTN, a WAP network, a Bluetooth network, a wireless LAN network, and/or an IP network such as the Internet, an intranet, or an extranet.

The back-end application computer server 550 may store information into and/or retrieve information from the insurance policy records 510. The insurance policy records 510 might, for example, store communication addresses and/or attribute values. The insurance policy records 510 may also contain information about past and current interactions with parties, including those associated with remote communication devices. According to this embodiment, the computer server 550 may also exchange information with a distribution center 570 (e.g., to arrange for postal mailing to be distributed in connection with upcoming audits), a telephone call center 572 (e.g., to arrange for telephone calls to be made in connection with upcoming audits), an email server 574, third-party data device 576 (e.g., to receive business credit score data, governmental information, etc.), and/or a predictive model 578.

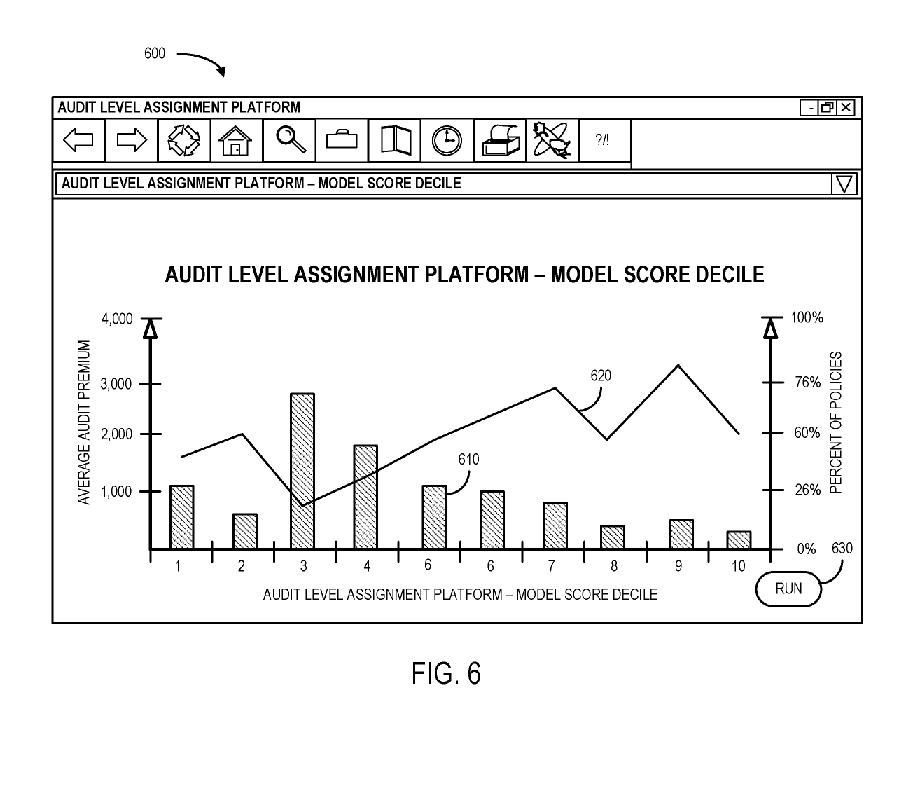

FIG. 6 illustrates an exemplary model score display 600 that might be associated with various embodiments described herein. The display 600 includes an X axis representing a model score decile (from 1 through 10) generated by an audit level assignment platform. The display 600 further includes a first Y axis representing an average audit premium 620 (based on a multivariate predictive model) and a second Y axis representing a percentage of overall insurance policies 610. Such a display 600 may let an operator quickly realize relationships between the model score deciles, average audit premiums and the overall percent of policies to help him or her determine how well a model is tracking an actual audit premium. A “Run” icon 630 might be selectable by a user to cause the system to re-allocate insurance policy audits (e.g., which might, for example, cause the information on the display 600 to be updated). Note that FIG. 6 is only an illustration of one way that data may be presented and embodiments may be associated with other types of data and/or other ways of presenting the data.

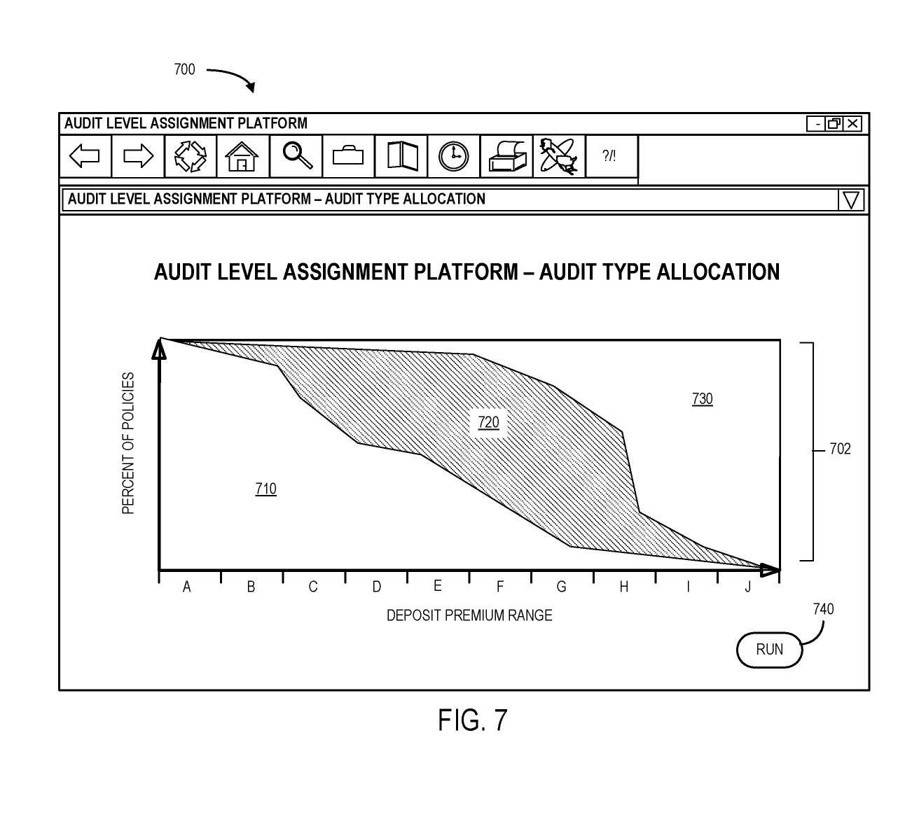

FIG. 7 illustrates an exemplary audit type allocation display 700 according to some embodiments of the present invention. The display 700 includes a chart 702 with an X axis representing a deposit premium range (from range “A” through range “J”). The display 700 further includes a Y axis representing a percentage of overall insurance policies that are assigned to a first audit level 710 (e.g., associated with statement or paper audits), a second audit level 720 (e.g., associated with telephone audits), and a third audit level 730 (e.g., associated with in-person physical inspection of an employer location) across the deposit premium ranges. Such a display 700 might, for example, let an operator quickly understand if resources are being allocated to various audit types in a logical and efficient manner. A “Run” icon 740 might be selectable by a user to cause the system to re-allocate insurance policy audits (e.g., which might, for example, cause the information on the display 700 to be updated).

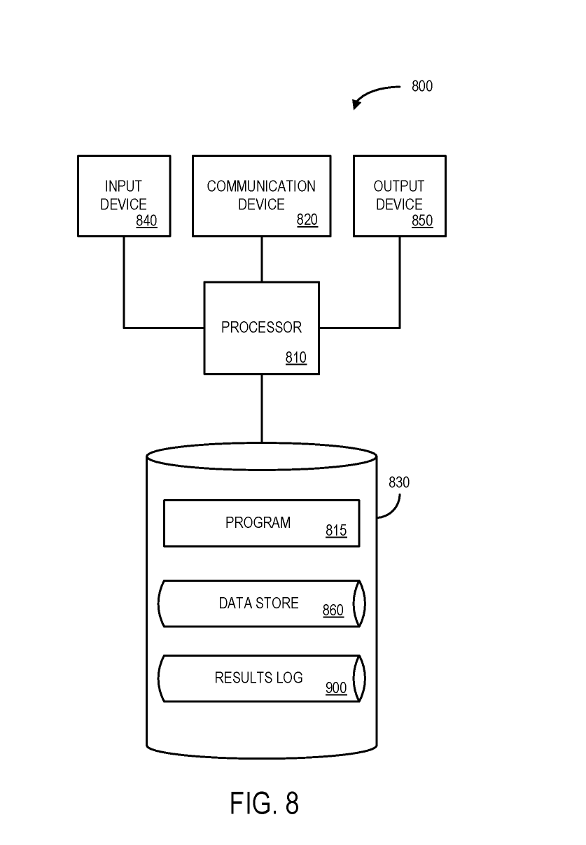

The embodiments described herein may be implemented using any number of different hardware configurations. For example, FIG. 8 illustrates a back-end application computer server 800 that may be, for example, associated with the systems 100, 500 of FIGS. 1 and 5, respectively. The back-end application computer server 800 comprises a processor 810, such as one or more commercially available Central Processing Units (“CPUs”) in the form of one-chip microprocessors, coupled to a communication device 820 configured to communicate via a communication network (not shown in FIG. 8). The communication device 820 may be used to communicate, for example, with one or more remote administrator computers and or communication devices (e.g., PCs and smartphones). Note that communications exchanged via the communication device 820 may utilize security features, such as those between a public internet user and an internal network of the insurance enterprise. The security features might be associated with, for example, web servers, firewalls, and/or PCI infrastructure. The back-end application computer server 800 further includes an input device 840 (e.g., a mouse and/or keyboard to enter information about target verification levels, email addresses, historic information, predictive models, etc.) and an output device 850 (e.g., to output reports regarding system administration and/or audit performance).

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 815 and/or a risk evaluation tool or application for controlling the processor 810. The processor 810 performs instructions of the program 815, and thereby operates in accordance with any of the embodiments described herein. For example, the processor 810 may access a data store having electronic records that represent a plurality of risk associations and, for each risk association, a set of attribute variables. Based on the set of attribute variables, the processor 810 may predict a future amount for each of the electronic records. Based on the future amounts, the processor 810 may automatically assign each of the electronic records to: a first level verification process subset, a second level verification process subset, or a third level verification process subset. The processor 810 may then create a results log and transmit indications associated with the results log to generate an interactive user interface display.

The program 815 may be stored in a compressed, uncompiled and/or encrypted format. The program 815 may furthermore include other program elements, such as an operating system, a database management system, and/or device drivers used by the processor 810 to interface with peripheral devices.

As used herein, information may be “received” by or “transmitted” to, for example: (i) the back-end application computer server 800 from another device; or (ii) a software application or module within the back-end application computer server 800 from another software application, module, or any other source.

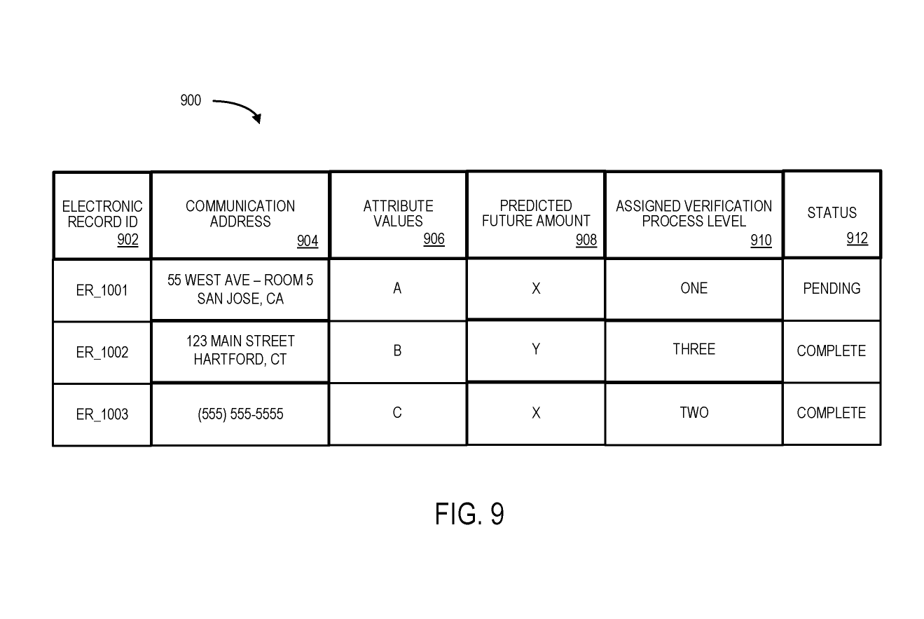

In some embodiments (such as shown in FIG. 8), the storage device 830 further stores a computer data store 860 (e.g., associated with a set of destination communication addresses, attribute variables, etc.) and a results log database 900. An example of a database that might be used in connection with the back-end application computer server 800 will now be described in detail with respect to FIG. 9. Note that the database described herein is only an example, and additional and/or different information may be stored therein. Moreover, various databases might be split or combined in accordance with any of the embodiments described herein. For example, the computer data store 860 and/or results log database 900 might be combined and/or linked to each other within the program 815.

Referring to FIG. 9, a table is shown that represents the results log database 900 that may be stored at the back-end application computer server 800 according to some embodiments. The table may include, for example, entries identifying insurance policies with upcoming (or recently completed) audits. The table may also define fields 902, 904, 906, 908, 910, 912 for each of the entries. The fields 902, 904, 906, 908, 910, 912 may, according to some embodiments, specify: an electronic record identifier 902, a communication address 904, attribute values 906, a predicted future amount 908, an assigned verification process level 910, and a status 912. The results log database 900 may be created and updated, for example, based on information electrically received from a computer data store and/or as audits are performed.

The message identifier 902 may be, for example, a unique alphanumeric code identifying an electronic record to be verified. The communication address 904 might represent a postal address, a telephone number, an email address, a web account user name and password, etc. The attribute values 906 might represent a state associated with an electronic record, a number of employees, etc. The predicted future amount 908 might represent, for example, a predicted future amount of a potential audit premium generated by a multivariate predictive model based on the attribute values 906. The assigned verification process level 910 might represent a type of audit that will be (or has been) performed for the electronic record identifier 902 (e.g., level “one,” “two,” or “three” or “statement,” “telephone call”, or “physical inspection”).

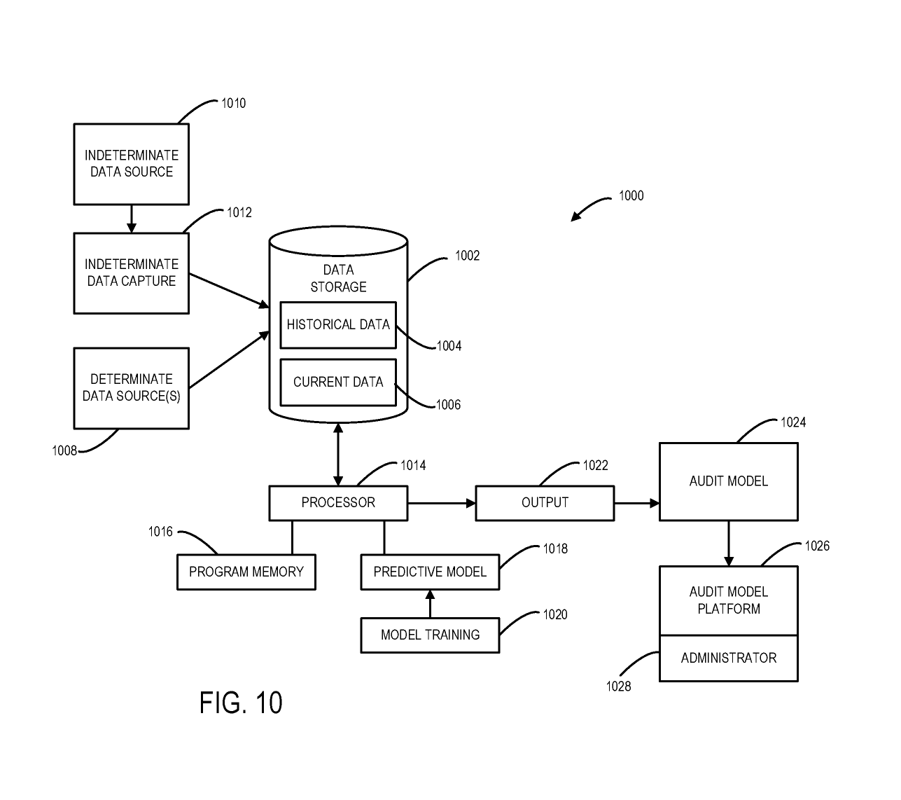

According to some embodiments, one or more predictive models may be used to select, create, and/or evaluate electronic messages. Features of some embodiments associated with a predictive model will now be described by first referring to FIG. 10. FIG. 10 is a partially functional block diagram that illustrates aspects of a computer system 1000 provided in accordance with some embodiments of the invention. For present purposes it will be assumed that the computer system 1000 is operated by an insurance company (not separately shown) for the purpose of supporting insurance policy audits (e.g., to confirm the accuracy of electronic records associated with insurance policies).

The computer system 1000 includes a data storage module 1002. In terms of its hardware the data storage module 1002 may be conventional, and may be composed, for example, by one or more magnetic hard disk drives. A function performed by the data storage module 1002 in the computer system 1000 is to receive, store and provide access to both historical transaction data (reference numeral 1004) and current transaction data (reference numeral 1006). As described in more detail below, the historical transaction data 1004 is employed to train a predictive model to provide an output that indicates an identified performance metric and/or an algorithm to score performance factors, and the current transaction data 1006 is thereafter analyzed by the predictive model. Moreover, as time goes by, and results become known from processing current transactions (e.g., audit results), at least some of the current transactions may be used to perform further training of the predictive model. Consequently, the predictive model may thereby appropriately adapt itself to changing conditions.

Either the historical transaction data 1004 or the current transaction data 1006 might include, according to some embodiments, determinate and indeterminate data. As used herein and in the appended claims, “determinate data” refers to verifiable facts such as the an age of a business; an automobile type; a policy date or other date; a time of day; a day of the week; a geographic location, address or ZIP code; and a policy number.

As used herein, “indeterminate data” refers to data or other information that is not in a predetermined format and/or location in a data record or data form. Examples of indeterminate data include narrative speech or text, information in descriptive notes fields and signal characteristics in audible voice data files.

The determinate data may come from one or more determinate data sources 1008 that are included in the computer system 1000 and are coupled to the data storage module 1002. The determinate data may include “hard” data like a claimant's name, date of birth, social security number, policy number, address, an underwriter decision, etc. One possible source of the determinate data may be the insurance company's policy database (not separately indicated).

The indeterminate data may originate from one or more indeterminate data sources 1010, and may be extracted from raw files or the like by one or more indeterminate data capture modules 1012. Both the indeterminate data source(s) 1010 and the indeterminate data capture module(s) 1012 may be included in the computer system 1000 and coupled directly or indirectly to the data storage module 1002. Examples of the indeterminate data source(s) 1010 may include data storage facilities for document images, for text files, and digitized recorded voice files. Examples of the indeterminate data capture module(s) 1012 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual.

The computer system 1000 also may include a computer processor 1014. The computer processor 1014 may include one or more conventional microprocessors and may operate to execute programmed instructions to provide functionality as described herein. Among other functions, the computer processor 1014 may store and retrieve historical insurance transaction data 1004 and current transaction data 1006 in and from the data storage module 1002. Thus the computer processor 1014 may be coupled to the data storage module 1002.

The computer system 1000 may further include a program memory 1016 that is coupled to the computer processor 1014. The program memory 1016 may include one or more fixed storage devices, such as one or more hard disk drives, and one or more volatile storage devices, such as RAM devices. The program memory 1016 may be at least partially integrated with the data storage module 1002. The program memory 1016 may store one or more application programs, an operating system, device drivers, etc., all of which may contain program instruction steps for execution by the computer processor 1014.

The computer system 1000 further includes a predictive model component 1018. In certain practical embodiments of the computer system 1000, the predictive model component 1018 may effectively be implemented via the computer processor 1014, one or more application programs stored in the program memory 1016, and computer stored as a result of training operations based on the historical transaction data 1004 (and possibly also data received from a third party). In some embodiments, data arising from model training may be stored in the data storage module 1002, or in a separate computer store (not separately shown). A function of the predictive model component 1018 may be to determine appropriate audit techniques for a set of insurance policies. The predictive model component may be directly or indirectly coupled to the data storage module 1002.

The predictive model component 1018 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 1000 includes a model training component 1020. The model training component 1020 may be coupled to the computer processor 1014 (directly or indirectly) and may have the function of training the predictive model component 1018 based on the historical transaction data 1004 and/or information about potential insureds. (As will be understood from previous discussion, the model training component 1020 may further train the predictive model component 1018 as further relevant data becomes available.) The model training component 1020 may be embodied at least in part by the computer processor 1014 and one or more application programs stored in the program memory 1016. Thus, the training of the predictive model component 1018 by the model training component 1020 may occur in accordance with program instructions stored in the program memory 1016 and executed by the computer processor 1014.

In addition, the computer system 1000 may include an output device 1022. The output device 1022 may be coupled to the computer processor 1014. A function of the output device 1022 may be to provide an output that is indicative of (as determined by the trained predictive model component 1018) particular performance metrics, automatically assigned audit verification processes, etc. The output may be generated by the computer processor 1014 in accordance with program instructions stored in the program memory 1016 and executed by the computer processor 1014. More specifically, the output may be generated by the computer processor 1014 in response to applying the data for the current simulation to the trained predictive model component 1018. The output may, for example, be a numerical estimate and/or likelihood within a predetermined range of numbers. In some embodiments, the output device may be implemented by a suitable program or program module executed by the computer processor 1014 in response to operation of the predictive model component 1018.

Still further, the computer system 1000 may include an audit model verification module 1024. The audit model verification module 1024 may be implemented in some embodiments by a software module executed by the computer processor 1014. The audit model verification module 1024 may have the function of rendering a portion of the display on the output device 1022. Thus, the audit model verification module 1024 may be coupled, at least functionally, to the output device 1022. In some embodiments, for example, the audit model verification module 1024 may report results and/or predictions by routing, to an administrator 1028 via an audit model verification platform 1026, a results log and/or automatically selected audit techniques generated by the predictive model component 1018. In some embodiments, this information may be provided to an administrator 1028 who may also be tasked with determining whether or not the results may be improved (e.g., by further adjusting which audit techniques will be associated with each insurance policy).

Thus, embodiments may provide an automated and efficient way to verify electronic records. The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of communication addresses, embodiments may instead be associated with other types of communications (e.g., chat implementations, web-based messaging, etc.). Similarly, although a certain number of verification levels were described in connection some embodiments described herein, other numbers of verification levels might be used instead (e.g., a system might automatically assign an electronic record to one of ten possible verification levels).

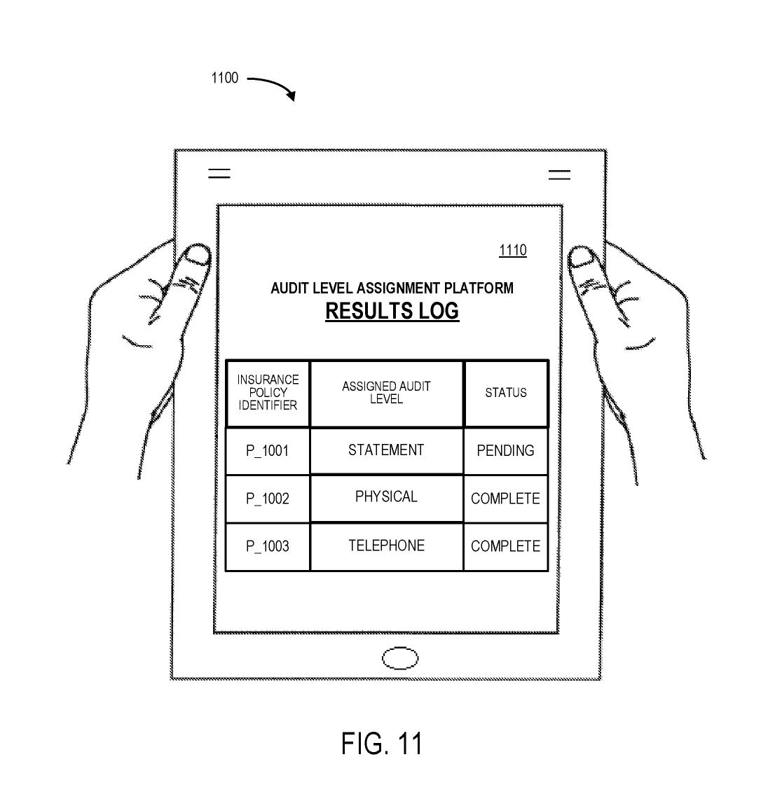

Still further, the displays and devices illustrated herein are only provided as examples, and embodiments may be associated with any other types of user interfaces. For example, FIG. 11 illustrates a handheld tablet computer 1100 displaying an audit level assignment platform results log display 1110 according to some embodiments. The results log display 1110 might include user-selectable graphical data providing information about electronic records (and audit levels that have been automatically assigned to each record) that can be selected and/or modified by a user of the handheld computer 1100.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to assign electronic records to verification process subset levels via an automated back-end application computer server, comprising:
(a) a data store containing electronic records representing a plurality of risk associations and, for each risk association, a set of attribute variables; and
(b) the back-end application computer server, coupled to the data store, programmed to:
(i) access the electronic records in the data store,
(ii) based on the set of attribute variables, automatically predict a future amount for each of the electronic records,
(iii) based on the future amounts and a predictive model, automatically assign each of the electronic records to one of the following verification process subset levels:
a first level verification process subset,
a second level verification process subset, the second level verification process subset being more thorough as compared to the first level verification process subset, and
a third level verification process subset, the third level verification process subset being more thorough as compared to the first and second level verification process subsets,
(iv) create a results log based on the automatic assignments of the electronic records, and
(v) transmit indications associated with the results log to generate an interactive user interface display; and
(c) a communication port coupled to the back-end application computer server to facilitate a transmission of electronic messages via a distributed communication network.

2. The system of claim 1, wherein each electronic record is associated with a communication address, and the first level verification process comprises sending a communication to the communication address and receiving, from a party associated with that electronic record, a response to the communication.

3. The system of claim 2, wherein the communication is associated with at least one of: (i) a postal mailing automatically generated by a distribution center, (ii) an email automatically generated by an email server, and (iii) a web interface.

4. The system of claim 3, wherein the response is associated with at least one of: (i) a mailing received by the distribution center, (ii) an interactive voice response system associated with the call center, (iii) customer information provided via the web interface, and (iv) a chat application that interacts with customers in substantially real time.

5. The system of claim 2, wherein the second level verification process comprises automatically establishing a communication link with the communication address, wherein the communication link is associated with at least one of: (i) a telephone call automatically placed from a call center, (ii) a video link, and (iii) a chat application that interacts with customers in substantially real time.

6. The system of claim 5, wherein each electronic record is associated with at least one physical location and the third level verification process comprises arranging a physical inspection at the least one physical location.

7. The system of claim 1, wherein the risk associations are associated with insurance policies and the automatically predicted future value comprises a future amount of a potential audit premium.

8. The system of claim 7, wherein at least one of the attribute variables is associated with at least one of: policy characteristics, deposit premium, industry classification, employee work-type classification, an indicator of policy changes, a policy endorsement indicator, a finding from a prior audit, a claim indicator, a billing/payment characteristic, billing method, payment method, payment frequency, and payment history.

9. The system of claim 8, wherein at least one of the attribute variables is associated with at least one of: third-party data, business credit data, governmental labor statistics economic data, and geodemographic data.

10. The system of claim 9, wherein each attribute variable is associated with a rank and said automatically predicted future amount of a potential audit premium is based at least in part on the ranks of the attribute variables.

11. The system of claim 7, wherein the automatic assignment of each of the insurance policies to the verification process subset levels is further based at least in part on pre-defined targets for each of the subset levels.

12. The system of claim 7, wherein at least one attribute variable is associated with at least one of: geographic information, a state identifier, a county identifier, and a ZIP code.

13. The system of claim 7, wherein at least one attribute variable is associated with at least one of: a measure of policy complexity, number of states, a number of classifications, and number of lines of business.

14. The system of claim 7, wherein the automatically predicted future amount of a potential audit premium is based on a model utilizing an absolute value of audit premiums.

15. The system of claim 7, wherein the automatically predicted future amount of a potential audit premium is based on a model utilizing at least one of: (i) a predicted amount of positive audit premiums, and (ii) a first model to predict a size of a predicted amount of positive audit premium, a second model to predict a size of a predicted amount of negative audit premium, and a third model to predict whether the predicted amount of audit premium would be positive or negative.

16. A computerized method to assign electronic records to verification process subset levels via an automated back-end application computer server, comprising:
accessing, by the back-end application computer server, a data store having electronic records that represent a plurality of risk associations and, for each risk association, a set of attribute variables;
based on the set of attribute variables and a predictive model, automatically predicting, by the back-end application computer server, a future amount for each of the electronic records;
based on the future amounts, automatically assigning, by the back-end application computer server, each of the electronic records to one of the following verification process subset levels:
a first level verification process subset,
a second level verification process subset, the second level verification process subset being more thorough as compared to the first level verification process subset, and
a third level verification process subset, the third level verification process subset being more thorough as compared to the first and second level verification process subsets;
creating, by the back-end application computer server, a results log based on the automatic assignments of the electronic records; and
transmitting, by the back-end application computer server, indications associated with the results log via a communication port to generate an interactive user interface display.

17. The method of claim 16, wherein each electronic record is associated with a communication address, and the first level verification process comprises sending a communication to the communication address and receiving, from a party associated with that electronic record, a response to the communication.

18. The method of claim 17, wherein the second level verification process comprises automatically establishing a communication link with the communication address, wherein the communication link is associated with at least one of: (i) a telephone call automatically placed from a call center, (ii) a video link, and (iii) a chat application that interacts with customers in substantially real time.

19. The method of claim 18, wherein each electronic record is associated with at least one physical location and the third level verification process comprises arranging a physical inspection at the least one physical location.

20. The method of claim 19, wherein the risk associations are associated with insurance policies and the automatically predicted future value comprises a future amount of a potential audit premium.

21. A non-tangible, computer-readable medium storing instructions, that, when executed by a processor, cause the processor to perform a method to assign electronic records to verification process subset levels via an automated back-end application computer server, the method comprising:
accessing, by the back-end application computer server, a data store having electronic records that represent a plurality of risk associations and, for each risk association, a set of attribute variables;
based on the set of attribute variables and a predictive model, automatically predicting, by the back-end application computer server, a future amount for each of the electronic records;
based on the future amounts, automatically assigning, by the back-end application computer server, each of the electronic records to one of the following verification process subset levels:
a first level verification process subset,
a second level verification process subset, the second level verification process subset being more thorough as compared to the first level verification process subset, and third level verification process subset, the third level verification process subset being more thorough as compared to the first and second level verification process subsets;
creating, by the back-end application computer server, a results log based on the automatic assignments of the electronic records; and
transmitting, by the back-end application computer server, indications associated with the results log via a communication port to generate an interactive user interface display.

22. The medium of claim 21, wherein each electronic record is associated with a communication address, and the first level verification process comprises sending a communication to the communication address and receiving, from a party associated with that electronic record, a response to the communication.

23. The medium of claim 22, wherein the second level verification process comprises automatically establishing a communication link with the communication address, wherein the communication link is associated with at least one of: (i) a telephone call automatically placed from a call center, (ii) a video link, and (iii) a chat application that interacts with customers in substantially real time.

24. The medium of claim 23, wherein each electronic record is associated with at least one physical location and the third level verification process comprises arranging a physical inspection at the least one physical location.

25. The medium of claim 24, wherein the risk associations are associated with insurance policies and the automatically predicted future value comprises a future amount of a potential audit premium.
